(19) United States
(12) Patent Application Publication
(10) Pub. No.: US 2011/0231483 A1
(43) Pub. Date: Sep. 22, 2011

(54) SYSTEM, METHOD AND COMPUTER PROGRAM FOR DELIVERY OF TARGETED INVITATIONS TO PARTICIPATE IN MARKET RESEARCH, BASED ON OBSERVED GEOSPATIAL BEHAVIOUR

(76) Inventors: Neil Alexander Derraugh, Rockland (CA); Sergey Vershinin, Ottawa (CA)

(21) Appl. No.: 13/052,042

(22) Filed: Mar. 18, 2011

Related U.S. Application Data
(60) Provisional application No. 61/315,536, filed on Mar. 19, 2010.

(51) Int. Cl. G06F 15/16

(52) U.S. Cl. 709/203

(57) ABSTRACT

The present invention provides a system, method and computer program for delivery of targeted invitations to participate in market research, based on observed geospatial behaviour. The geospatial behaviour is not limited to location information but includes behavioural information including, for example, direction, speed, acceleration, route, movement pattern, time and other information related to geospatial information. Based on the geospatial information and project criteria established by market researchers, decisions may be automatically made regarding whether to invite particular market research panel members to participate in market research, for example by the completion of one or more surveys.

### CROSS-REFERENCE TO RELATED APPLICATIONS

This application claims the benefit of co-pending U.S. Provisional Application No. 61/315,536, filed 19 Mar. 2010, which is hereby incorporated herein.

### FIELD OF THE INVENTION

The present invention relates generally to electronic delivery of content. The present invention more specifically enables delivery of content to a mobile device based on observed geospatial behaviour.

### BACKGROUND OF THE INVENTION

Market research is an information gathering activity pertaining to opinions, views, preferences, characteristics (demographic and otherwise), attributes, and behaviours of individual research participants. The market research industry involves a number of actors, with the main four types being research users, researchers and research companies, service and technology providers, and research participants.

The main consumers of market research are private sector companies seeking to better understand the market for their products or services. In order to carry out market research activities companies either commission outside researchers or conduct market research studies using in-house resources. The typical objectives of market research include evaluating customer satisfaction with existing products or services, seeking market opportunities for new products or services based on gaps in existing offerings, testing products or services before or after they are brought to market, and engaging in competitive intelligence gathering (i.e. looking to better understand the market through a thorough assessment of competing offerings). Additional research objectives may include testing of marketing activities including advertising research both prior to, during, and after the launch of an advertising campaign.

To a lesser extent, public sector organizations also use the services of the market research industry, sometimes for reasons similar to that of private sector firms (i.e. market insight), and more often in order to conduct what is better characterized as public opinion research. Public opinion research differs from market research in its objectives: instead of looking to increase return on investment (ROI), the research is usually aimed at obtaining information to drive development of public policy and programs.

Both private and public sector actors also engage in performance measurement activities, and comprehensive evaluations. This type of research is used to examine business practices as well as public sector programs and activities, looking to identify areas for improvement of their efficacy and efficiency.

On the supply side of the market research industry, a large number of companies provide a wide variety of services to meet the demands put forth by research users. These companies vary both in size as well as specialization. Aside from specializations in subject matter areas (food and beverage, entertainment, high-tech etc.), market research companies also differ in the manner in which they provide their services. The two main types of services are custom and syndicated research.

Custom market research studies are done to meet a specific information need of a specific client. Although often conducted as a one-off project, a custom research project may lead to follow-up projects looking to expand or deepen the initial scope of research, or for the purpose of tracking shifts in consumer opinions, preferences, and behaviour over time. However, the main differentiating feature of custom research is that it is initiated by and is conducted for a specific client.

Syndicated research activities differ from custom research in that they are undertaken by a research provider with the expectation of selling the information to a number of research users. Syndicated studies are often on-going, and generate reports that are then purchased by various companies who are interested in the information contained therein. An example of this would be the market research firm that conducts on-going research on eating and food buying habits of Americans, which then sells this information to companies that provide food and beverage services to the American market (producers, retailers, industry associations, etc.) Syndicated research employs economies of scale to provide research information at a lower price, usually by looking at markets or issues that can be reasonably assumed to be of interest to a number of potential clients.

Depending on research objectives, both custom and syndicated research can employ a number of different qualitative and quantitative research methodologies, including in-person interviews, focus groups, telephone and mail surveys, ethnographic research, as well as various forms of online research. The latter, has been a growing area for market research services, driven both by lower cost as well as the large variety of types of research made possible by computer and telecommunications technologies.

The process of conducting market research involves a host of activities which may or may not be offered directly by the research provider contracted to deliver the information to the research user. Moreover, in some cases the company seeking to obtain market research information will employ in-house resources to carry out the research. As such, contracting or purchase of tools and services dealing with a specific subset of the market research value chain is a common practice. In fact, there is a multitude of companies whose sole business is to provide specialized services or tools required to enable the conduct of market research activities.

Services provided by such companies include, among others: (i) sales of contact information for hard to reach populations (firms that purchase specific services, consumers that fit a narrowly defined demographic criteria, etc.) to enable survey sample development (e.g. ASDE Survey Sampler™); (ii) rental of focus group and other types of interviewing facilities; (iii) telephone and online data collection, via a call centre or an online survey application server; (iv) data aggregation and processing, including coding of open-ended feedback and transcription services; (v) statistical data analysis, for projects involving complex tasks that a research firm may not have experience with, or does not have the specialized software to undertake; and (vi) reporting, especially in the context of reporting automation that involves production of multiple custom reports from the same dataset.

What has not been provided to date is a highly efficient means by which to select and manage research panels. Conducting most types of market research would not be possible without the willing participation of the people whose views, attitudes, and behaviours constitute the essence of the information sought by businesses and public sector organizations. The three main types of research participants include those randomly recruited for a specific research study, existing customers of a firm seeking market research information, and members of a research panel.

Randomly recruited participants are often involved in a specific study, with no on-going relationship outside of their immediate participation. However, random recruitment may form the basis for panel studies (tracking a group of research subjects over time) or be employed as a means of developing a research panel which will be drawn on for multiple research studies at a later date.

Existing customers are often tapped for feedback on the products or services offered by a firm, and while their participation in market research studies may be a one time engagement, they do represent a population with an existing and on-going relationship to the company commissioning the research.

Research panel members are individuals who have consented to be invited to participate in research studies on an on-going basis. Given that the nature of research panels varies, the relationship between the research participant and the research panel they are a member of may be based on an interest in the products or services of a given firm, or a research firm that manages the panel.

Finally, it is important to mention that the motivations for participation in a research study vary on a case by case basis. While much of public opinion research is conducted without the use of incentives given the public interest aspect of such research, market research studies often use incentives such as cash of prize draws to stimulate interest. Moreover, research panels often employ a point system that rewards the panel member for taking surveys. The points earned in this manner can then be used to “purchase” various items such as gift cards and other consumer goods.

The utility of market research activities is determined by how closely the obtained information relates to the specific good or service of interest. Thus, the best possible market research data is usually obtained by custom market research studies that often represent a significant investment of time and money.

The response rate for the random approach (i.e. the ratio of contacted persons to completed surveys), tends to be quite low due to a number of factors, including complexity of eligibility criteria, level of interest in regard to the issue in question, or general lack of interest in participating in market research studies. The last factor behind low response rates can be mitigated through the use of research panels, which obtain prior consent from potential respondents for taking part in market research studies.

Moreover, to improve targeting of survey invitations, research panels maintain profiles that include demographic characteristics as well as issues and subjects of interest to each individual panel member.

Targeting of potential survey respondents according to their behaviour remains elusive. This is because unlike demographic characteristics which are easily captured, and are not subject to constant change, the sheer diversity and time sensitivity of behavioural information make it difficult, and in some cases impossible, to maintain such information for each member of the research panel. At best the panel member profile may contain behavioural information gathered in the past. However, such information is still of limited utility when dealing with a research study that needs to examine a new type of behaviour.

PCT/CA2009/000331 to Techneos Systems Inc. teaches a method and system for conducting a survey by using a wireless device. The method involves: downloading from the server during the connection period a metadata variable; displaying on the display screen of the wireless device presentation information associated with the metadata variable; receiving user input in response to the presentation information; after receiving the user input, allocating memory of the memory circuit for storing the user input in association with the metadata variable; and storing the user input in the memory in association with the metadata variable. A system for conducting a survey by a wireless device includes a server and a plurality of the wireless devices. However, Techneos Systems Inc. does not teach targeting delivery of the survey to optimize participation and relevance.

PCT/IL2008/000282 to Invoke Solutions Inc. teaches a method of conducting a survey, comprising: displaying a notification on a survey at a plurality of locations, the notification in each location including a unique code different from the codes of the other locations; receiving, by a survey server, requests to participate in the survey with the unique codes from a plurality of mobile stations; determining, by the survey server, for each received request, whether to allow a holder of the mobile station to participate in a survey; conducting a survey, by the survey server, through the mobile stations whose holders were determined to participate in a survey, analyzing by the survey server responses received in the survey, so as to generate survey results, and displaying the survey results of the plurality of locations, by the survey server. However, Invoke Solutions Inc. does not teach targeting delivery of the survey based on geospatial information other than location, which can be of limited value.

What is required, therefore, is a method of targeting delivery of a market research invitation based on more than just location, by using information regarding the behaviour of an eligible participant's geospatial activities as a means for determining whether an invitation should be sent.

### SUMMARY OF THE INVENTION

The present invention provides a system, method and computer program for electronic delivery of content to a mobile device based on meeting defined geospatial behaviour criteria.

The present invention also provides a system for delivery of content based on observed geospatial behaviour, the system comprising: (a) a network accessible server configurable to deliver one or more project criteria and content based on the project criteria, the project criteria including geospatial criteria; and (b) one or more mobile devices operable to obtain geospatial behaviour information and to obtain the content from the server if the geospatial behaviour information meets the geospatial criteria.

In another aspect of the invention, the system comprises: (a) a network accessible server configurable to deliver content to one or more mobile devices based on one or more project criteria, the project criteria including geospatial criteria; wherein the server includes or is linked to a database of content and is operable to associate the content with the project criteria; wherein the server is operable to receive geospatial behaviour information from one or mobile devices participating in the content deliver, wherein the server delivers the content to one or more of the mobile devices if the geospatial behaviour information meets the geospatial criteria.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

FIG. 1 illustrates a system in accordance with one embodiment of the present invention.

FIG. 2 illustrates a process for a market researcher to establish a market research project, and a process for a research panellist to access and complete a market research survey.

FIG. 3 illustrates a point of interest and its associated radius.

FIG. 4 illustrates a point of interest, its associated radius and an associated arc of approach.

FIG. 5 illustrates a polygonal point of interest.

### DETAILED DESCRIPTION

The present invention provides a system, method and computer program for electronic delivery of content to a mobile device based on meeting defined geospatial behaviour criteria. In a particular implementation, the invention enables delivery of targeted invitations to participate in market research based on observed geospatial behaviour. The geospatial behaviour is not limited to location information but includes behavioural information including, for example, direction, speed, acceleration, route, movement pattern, time and other information related to geospatial information. Based on the geospatial information and project criteria established by market researchers, decisions may be automatically made regarding whether to invite particular market research panel members to participate in market research, for example by the completion of one or more surveys. The project criteria in part comprise geospatial criteria. Preferably, the project criteria are designed based on likely behaviours or experiences of the panel members that happen to satisfy the criteria. For example, the criteria could be based on travelling in a particular direction at a particular location so as to be exposed to a particular advertisement and the survey is based on feedback to the advertisement. It could also be in part based on time so as to determine when the panel member would have been exposed to the particular advertisement.

The invention enables targeted market research to be delivered to panel members' mobile devices based on the panel members' geospatial behaviour and/or demographic profiles. Market research ROI is maximized through automation of research subject identification and delivery of survey invitations to eligible research subjects. It should be understood that while the present description discusses the use of the present invention in association with market research delivery, the present invention could also be used to disseminate any type of content based on observed geospatial behaviour and/or demographic profiles.

The invention allows market researchers to specify geospatial criteria, and have the system deliver, via a mobile device, an invitation to take part in a market research survey to eligible research panel members based on their geospatial behaviour.

In addition to automating the task of identifying eligible respondents based on geospatial behaviour, the response rate for surveys is likely to improve given that panel members would be invited to participate in a study related to a location relevant to them (e.g. one they had recently visited) or an activity relevant to them (e.g. one they had likely engaged in given their recent geospatial behaviour). Moreover, the increased relevance of the subject matter of is likely to improve the research panel retention rate, introducing further costs savings by keeping the panel members engaged and interested in participating in further studies.

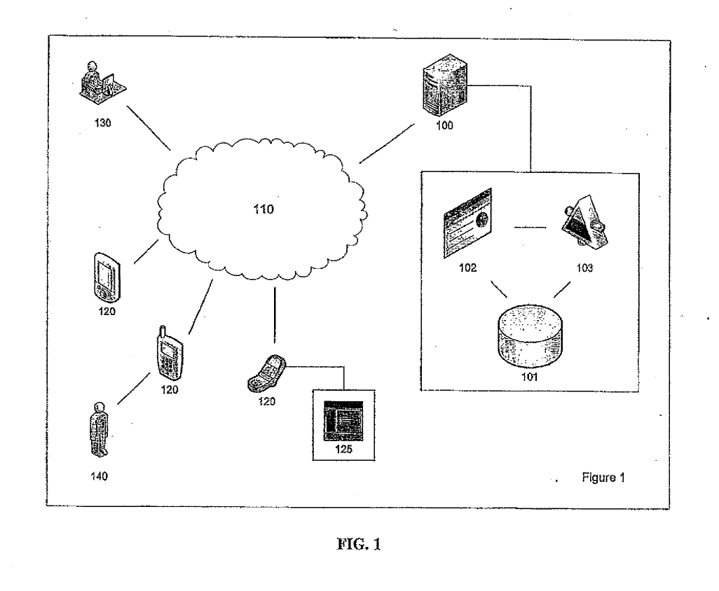

A system in accordance with the present invention is shown in FIG. 1. The system comprises a server (100) accessible from one or more mobile devices (120) over a network (110). The network may include means for wireless access, such as, for example, a wireless gateway, cellular transceiver, WiMax base station, etc. so as to enable wireless data communication. The server includes (100) or is linked to a database (101) for storing project, client, and user data, a web application (102) to provide a user interface for market researchers (130) to interact with the system, and web services (103) which provide a two way communications channel between the server (100) and a mobile client (125) linked to a mobile device (120).

Each research panel member (140) is equipped with a mobile device (120) that may include or be linked to a mobile client enabling communication between the mobile device and the server via the web services (103). The mobile device is operable to provide geospatial information to the mobile client through geo-location obtaining means. It should be understood that geo-location obtaining means includes any technology that is operable to enable a mobile device to determine its geospatial coordinates and/or any technology that a mobile device may use to allow the mobile device's location to be inferred. Examples of geo-location obtaining means include Global Positioning System (GPS), cellular tower triangulation, Radio Frequency Identification (RFID), and 802.11 (Wi-Fi) access point or Bluetooth proximity detection. The mobile device of the present invention includes any portable electronic device capable of establishing a wireless connection to a network, determine its geospatial coordinates through the use of some form of geo-location obtaining means, and host or link to a mobile client. Examples of such mobile devices include smartphones, personal digital assistants, laptop computers, netbooks, etc.

It should further be understood that the present invention may be provided as a full-service, stand-alone web application combined with a panel or individuals who have installed the mobile client on their mobile device or made the mobile client accessible from their mobile device; a software-as-a-service (SaaS) model aimed at augmenting capabilities of existing research panels owned by other companies; a strictly technology-oriented solution that is offered to various data collection software providers for integration with their proprietary data collection software, or another type of deployment; or any other deployment that enables the techniques described herein. The mobile client may be deployed to the mobile device by: (i) installation to the mobile device initiated by the research panel member; (ii) installation to the mobile device initiated by an invitation sent to the research panel member from the market researcher, enabling the research panel member to install the mobile client; (iii) preinstallation; (iv) accessing a hosted solution from the mobile device; or (v) other means for hosting or linking the mobile client with the mobile device. The mobile client can be implemented using computer hardware, firmware, software, or any combination thereof. In one embodiment, the mobile client is implemented as a computer program product comprising a computer-readable memory storing computer executable instructions thereon that when executed by a computer cause media content from a network accessible source to be delivered to a mobile device based on observed geospatial behaviour of a user of the mobile device. In another embodiment, the mobile client comprises a device module for receiving geospatial data from a location identifying device and deriving user behaviour information from the geospatial data; a project module for receiving content and geospatial behaviour criteria from the network accessible content source; and a processing module for delivering content to the mobile device when the behaviour information of the user matches the geospatial behaviour criteria.

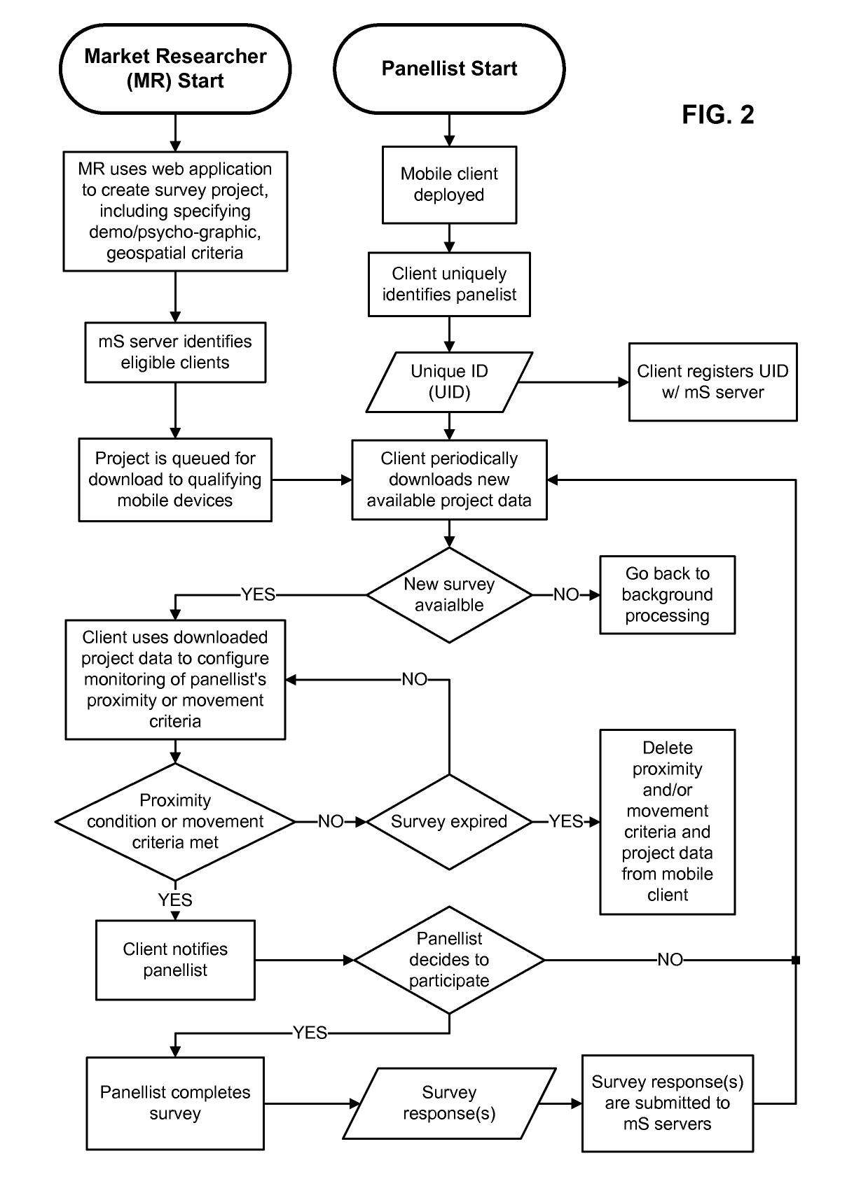

FIG. 2 illustrates an example of a market researcher establishing a market research project and a research panellist accessing and completing a market research survey. In this particular example, the mobile client is operable to collect survey responses from the panel member. In another example, the mobile client may activate a third party survey software application to present the survey and collect the panel member's responses. In yet another example, the mobile client may present the panel member with an invitation to complete a survey via a web browser or other service-based approach.

The web services provide communication or data transmission capabilities between the mobile device and the server. The mobile device may include a mobile client capable of making web requests and responses to the server. The web server may include database driven services that serve information which may or may not require authentication. The types of information communicated or data transmitted to the server may include identifying/authentication information such as a username and/or password, or another unique identifier; survey responses; receipt of information acknowledgements; geo-location information or behaviour or patterns. The types of information communicated or data transmitted to the mobile device may include geospatial points of interest or behaviour or patterns; survey questions or other survey elements (audio, video, images, etc.); receipt of information acknowledgements; post survey completion messages or information.

The web application provides an interface for market researchers to establish parameters and content of a market research project and monitor and control delivery of survey invitations and data collection processes. The parameters include demographic and/or geospatial criteria (e.g. geographical points of interest, direction, speed, etc.) that, if met by a particular registered mobile client, enable delivery of a market research survey to research panel member to which the mobile client is associated. The content may include a link to a survey, text of a research project invitation, data collection timing (e.g. when to start and when to stop issuing invitations to participate in this research project) and duration information. The web application may also provide monitoring of delivery of survey invitations and data collection progress.

The database stores data on research projects initiated by market researchers, mobile clients registered with the system and user access. Research project data may include the information provided by the market researchers by means of the web application. Mobile client data may include a unique identifier for each registered mobile client, data on current and past research projects that the client has qualified for, been issued an invitation for, or has otherwise participated in, and the demographic and psychographic profile of the research panel member associated with the mobile client. User access information may include information on the market researchers authorised to access the system such as their username, password, projects they own or have access to, and other such information pertaining to the scope of access to and usage of the system. Demographic and psychographic profile data may include information pertaining to the panel member such as their age, gender, place of residence, interests, hobbies, etc.

The mobile client is operable to track the panel member's geographical position in the real world and is operable to obtain a survey invitation from the server once proximity to a point of interest or a movement pattern criterion has been satisfied. The mobile client may also reference available project criteria, including geospatial criteria, to check if any of them have been met. The mobile client can store information, including but not limited to project criteria, research panel member's demographic and psychographic profile, and application preferences data. Application preferences data includes the frequency with which the panel member can be invited to participate in research, frequency of reminders that can be provided once the panel member has qualified for but has postponed taking the survey, and other information pertaining to the functionality of the mobile client. Application preferences data may be configured by the panel member, market researcher, or an administrator of the system. The mobile client may alternatively provide geospatial behaviour information to the server and the server may be operable to determine whether the mobile device corresponding to the mobile client has satisfied project criteria so as to enable the delivery of the survey invitation to the mobile client.

The mobile client may periodically obtain new project data from the server. The mobile client may query the server to determine whether new projects are available. If so, the project may be downloaded to the mobile client and new parameters for survey invitation may be added to the mobile client's list of active research projects. The mobile client uses project data and the geo-location obtaining means of the mobile device to determine whether the research panel member is within the proximity of a point of interest or meets geospatial behaviour criteria. If and when the survey invitation criteria are met, the mobile client may notify the research panel member and present an invitation to participate in the research survey, including the link to the survey itself. If the panel member agrees to participate, the survey may be presented to the panel member by means of the mobile client, activation of a third party survey software application, web-based survey or other service-based approach, etc. Once the panel member completes the survey, the mobile client notifies the server via web services. If the period of the project expires without the invitation to survey being extended, the project data may be deleted from the mobile client.

In certain circumstances, the geo-location obtaining means may require significant power from the mobile device. The mobile client may enable a conservation mode wherein the geo-location obtaining means is enabled for a short period to obtain location information and then disabled for a period to conserve power. The conservation mode may have a frequency of enabling the geo-location obtaining means that includes: (i) enabling the geo-location obtaining means as a function of the distance from the nearest point of interest, such that it increases as the panel member approaches the point and decreases as they travel away from the point; (ii) enabling the geo-location obtaining means as a function of the patterns of movement, for example someone who regularly appears in two different cities, or someone who appears to travel regularly during rush hour; or (iii) some combination thereof.

The mobile client also tracks and stores frequently accessed information such as points of interest and movement criteria. For example, the points of interest can define a geospatial polygon such that the delivery of an invitation to the mobile client is initiated when a panel member enters the geospatial polygon. The points of interest and movement criteria can also define a polygon or arc and an approach vector such that the mobile client initiates the delivery of the invitation when the panel member enters the polygon or arc from a particular direction, angle, speed, etc.

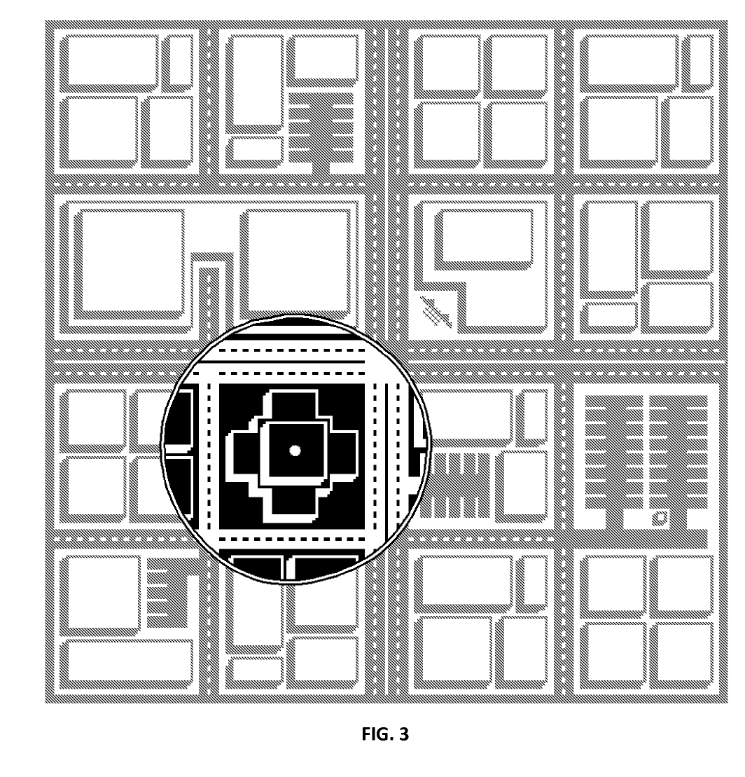

FIGS. 3 to 5 illustrate potential points of interest and geospatial regions in accordance with which invitations are deliverable to mobile clients.

FIG. 3 illustrates a point of interest and its associated radius. If a panellist enters the circle defined by the point of interest and its radius, an invitation may be delivered to the panellist to participate in a survey. A potential application of such an approach to defining the geospatial region is to encourage a panellist to participate in a survey related to the point of interest being approached.

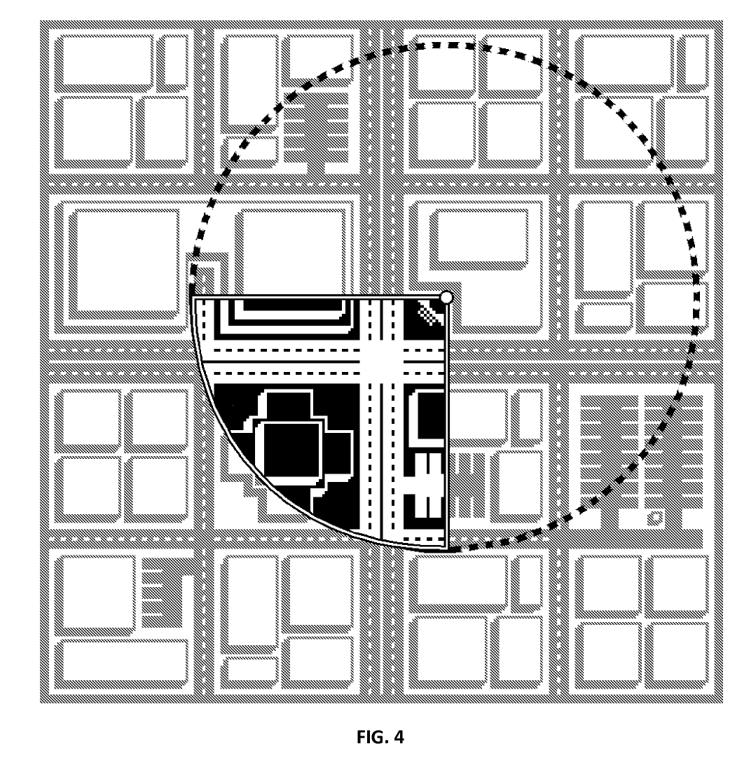

FIG. 4 illustrates a point of interest, its associated radius and an associated arc of approach. In this case, the market researcher may specify that an invitation is to be sent out to panel members that enter the defined geospatial region from the direction of the arc, and not from other directions. If any of the criteria (distance from the point of interest, approach angle, etc.) are not met then the invitation would not be issued. A potential application of such an approach to defining the geospatial region is to encourage a panellist to participate in a survey related to the point of interest being approached from a particular direction.

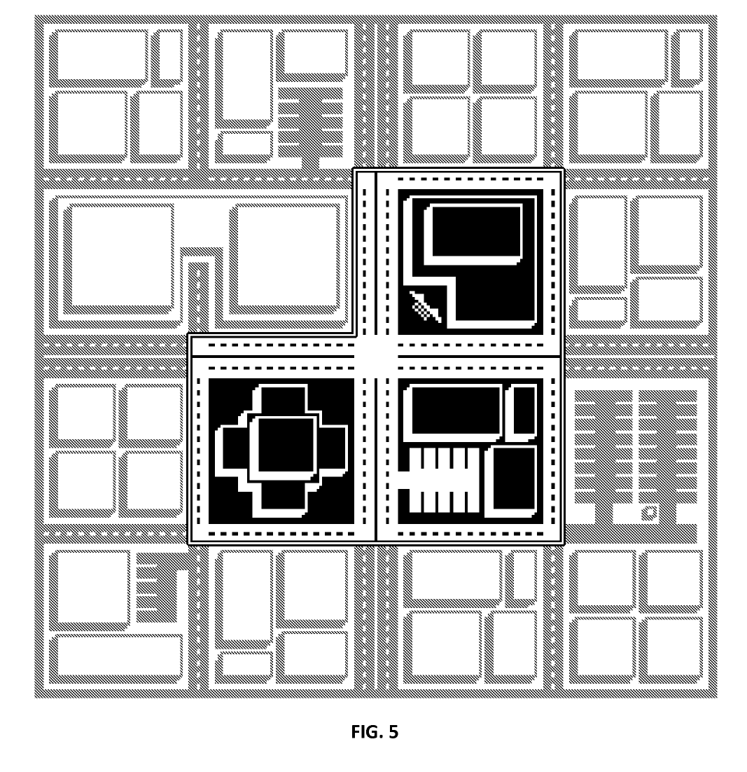

FIG. 5 illustrates a polygon of interest. The market researcher can specify any number of points to define the polygon and can define directions, speeds, etc. according to which a panel member must be behaving in order for an invitation to be delivered.

The invitation may include a link to the survey with introductory text. The mobile client enables the panel member to complete the survey by means of the mobile device and to send the survey results to the server for compilation. The survey can include any number of multiple choice, text answer based and/or dynamic questions as desired by the market researcher. As previously mentioned, this can be accomplished by the mobile client, a third party survey software application, web-based or other service-based approach. In the case of a third party survey software application, or a web-based/service-based approach, the mobile client may be operable to obtain the survey results from the third party survey software application or web-based/service-based, as the case may be, in order to provide the results to the server.

In one example of the present invention, it can be used for evaluating an advertising billboard. For example, a company may want to evaluate the impact of an outdoor advertising campaign. The market researcher would identify by means of the web application the coordinates of the billboard carrying the outdoor ads, as well as the direction in which they are facing. The market researcher would determine a region and direction of interest to enable sending of invitations to research panellists. Once the project is initiated, and the data is communicated to the mobile clients deployed in the area, any panel member coming into close proximity of the billboard, from a direction where they are reasonably likely to see the billboard, would receive an invitation to provide their feedback on the impact of the outdoor advertising campaign.

In another example of the present invention, it can be used to gather intelligence on a competing chain of grocery stores. For example, a company may be seeking to lure customers from a competing chain of grocery stores. The market researcher would identify the locations of the competitor's stores, and upload the data to mobile clients belonging to a target demographic being sought after (e.g. female, 25-34, $50K+). Upon exit from the location of interest the eligible panel member would receive an invitation to discuss their shopping experience and answer questions pertaining to possible ways they could be persuaded to go to a competitor's store.

In another example of the present invention, it can be used to conduct market research with individuals who regularly perform physical activities. For example, a company may be interested in hearing from cyclists who ride off-road trails on mountain bikes and who come within a particular distance from the company's storefront. The market researcher may define the movement criteria of someone who rides a bicycle on off-road trails, for example by defining travel with variable speed between 5-50 km/h for 30 minutes or more, in combination with defining regions that would constitute being “off-road”. When an individual carrying a mobile device having the mobile client thereon meets these criteria, the eligible panel member would receive an invitation to provide his or her preferences regarding products and services in the cycling industry.

In another example of the present invention, it can be used to conduct market research studies with individuals who are frequent patrons of drinking establishments. For example, the researcher may identify locations of sports bars and request to identify individuals who visited these locations at times coinciding with sporting events such as hockey or football games. Individuals identified as meeting a pre-defined demographic criteria (e.g. 18-25 years of age), and as being regular visitors of sports bars during sporting events, would then be invited to participate in a survey looking to gather information about association between alcoholic beverages and sporting events, for use in marketing and branding activities.

In yet another example of the present invention, a company may wish to gather market research information about the motivations behind the choice of business clothing purchase. In this example, the market researcher may identify retail locations that specialize in sales of suits and business clothes. Individuals who meet the criteria of having stayed in the identified area for a set minimum amount of time will have likely either made a business clothing purchase, or be in the process of making a purchase decision. The relevancy of the survey topic (business clothing) and the timing of the invitation would both increase the likelihood of survey participation and improve the data quality.

1. A system for delivery of content, the system comprising:
(a) a network accessible server in communication with a mobile client;
(b) a mobile device having means for providing geospatial behaviour information thereof; and
(c) a mobile client in communication with the mobile device, the mobile client comprising:
(c1) means for receiving one or more project criteria and content associated therewith from the network accessible server,
(c2) means for determining whether the geospatial behaviour information matches the project criteria, and
(c3) means for delivering the content associated with the project criteria to the mobile device.

2. The system of claim 1, wherein the project criteria comprise geospatial criteria, said geospatial criteria comprising at least one of location, direction, speed, acceleration, route, movement pattern, and time.

3. The system of claim 1, wherein the geospatial behaviour information comprises at least one of location, direction, speed, acceleration, route, movement pattern, and time.

4. The system of claim 1, further comprising a user interface accessible by one or more market researchers, the user interface enabling the market researchers to configure the project criteria corresponding to delivery of the content.

5. The system of claim 1, wherein the content is a survey and wherein the system further comprises means for providing survey responses to the server upon completion of the survey.

6. The system of claim 1, wherein the project criteria further comprise demographic profiles of a user of the mobile device.

7. The system of claim 1, wherein the mobile device comprises the mobile client.

8. The system of claim 1, wherein the network accessible server comprises the mobile client.

9. A method of delivering content to a mobile device, the method comprising the steps of:
(a) receiving geospatial behaviour information of the mobile device;
(b) receiving one or more project criteria and content associated therewith from a network accessible server; and
(c) if the geospatial behaviour information matches the project criteria, delivering the content associated with the project criteria to the mobile device.

10. The method of claim 9, wherein the project criteria comprise geospatial criteria, said geospatial criteria comprising at least one of location, direction, speed, acceleration, route, movement pattern, and time.

11. The method of claim 9, wherein the geospatial behaviour information comprises at least one of location, direction, speed, acceleration, route, movement pattern, and time.

12. The method of claim 9, wherein the content is a survey and wherein the method further comprising the step of:
(d) providing survey responses to the server upon completion of the survey.

13. The method of claim 11, wherein the project criteria further comprise demographic profiles of a user of the mobile device.

14. A computer program product for delivering content to a mobile device, the computer program product comprising a computer-readable memory storing computer executable instructions thereon that when executed by a computer perform the steps of:
(a) receiving geospatial behaviour information of the mobile device;
(b) receiving one or more project criteria and content associated therewith from a network accessible server; and
(c) if the geospatial behaviour information matches the project criteria, delivering the content associated with the project criteria to the mobile device.

15. The computer program product of claim 14, wherein the project criteria comprise geospatial criteria, said geospatial criteria comprising at least one of location, direction, speed, acceleration, route, movement pattern, and time.

16. The computer program product of claim 14, wherein the geospatial behaviour information comprises at least one of location, direction, speed, acceleration, route, movement pattern, and time.

17. The computer program product of claim 14, wherein the content is a survey and wherein the steps further comprising the step of:
(d) providing survey responses to the server upon completion of the survey.

18. The computer program product of claim 14, wherein the project criteria further comprise demographic profiles of a user of the mobile device.
